(19) United States
(12) Patent Application Publication
(10) Pub. No.: US 2007/0281759 A1
(43) Pub. Date: Dec. 6, 2007

(54) PROCESSING A REPLY IN THE MOBILE COMMUNICATION TERMINAL

(75) Inventor: Changkeun Choi, Seoul (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG ELECTRONICS INC.

(21) Appl. No.: 11/757,940

(22) Filed: Jun. 4, 2007

(30) Foreign Application Priority Data
Jun. 5, 2006 (KR) 10-2006-0050570

(51) Int. Cl. H04M 1/00

(52) U.S. Cl. 455/575.1

(57) ABSTRACT

Disclosed are a mobile communication terminal and a method for processing a reply in the mobile communication terminal that can send a previously designated text message through a simple exterior key operation when a call, a message or a mail is received.

### CROSS-REFERENCE TO RELATED APPLICATIONS

The present application claims priority from Korean Patent Application No. 10-2006-005057, filed on Jun. 5, 2006, the entire contents of which is incorporated herein by reference.

### BACKGROUND

1. Field of the Invention

This document relates to a mobile communication terminal and a method for processing a reply in the mobile communication terminal. More particularly, this document relates to a mobile communication terminal and a method for processing a reply in the mobile communication terminal that can send a previously designated text message through a simple exterior key operation when a call, a message or an mail is received.

2. Related Art

Recently, with rapid increase of a user of a mobile communication terminal, a mobile communication field has been advanced rapidly. Thus, the user's desires for a quality of a mobile communication service have been also increased.

Many service providers provide diverse additional services in order to satisfy the user's desires.

The mobile communication terminal provided with diverse additional services can connect a phone call to a caller's terminal or send the message or the mail to inform a caller of the receiver's situation, after denying an incoming call, rejecting call receipt, and getting silent mode.

However, a method for informing the caller of the receiver's situation and message contents have a problem that the mobile communication terminal should again connect the phone call to the caller's terminal and send the message or the mail to the caller.

In reply disable situations such as meeting, studying, calling, driving, and others, when the caller call the receiver on the phone, the receiver can not inform the caller of his/her situations promptly.

In other words, since a folder type mobile communication terminal should connect the phone call after opening a folder in order to reply to the phone call, the message or the mail, or pass through various paths to compose the message or mail, the receiver can not inform the caller of his/her situation promptly.

### SUMMARY

Accordingly, the present invention has been made to solve the above-mentioned problems occurring in the prior art, and an object of the present invention is to provide a mobile communication terminal and a method for processing a reply in the mobile communication terminal that can simply send a previously designated text message through a simple exterior key operation when a call, a message or an mail is received.

Additional advantages, objects and features of the invention will be set forth in part in the description which follows and in part will become apparent to those having ordinary skill in the art upon examination of the following or may be learned from practice of the invention. According to an aspect of the present invention, there is provided a mobile communication terminal, which comprises: a memory storing a previously designated reply text message; and a controller displaying a reply menu to be selectable to an exterior key on a outer display or an inner display and sending a corresponding reply text message stored in the memory according to selection of the menu, when a call, a message or an mail is received.

According to another aspect of the present invention, there is provided a mobile communication terminal, which comprises: a memory storing at least one or more of previously designated key data and at least one of reply text messages; and a controller receiving the key data through a key operation to send the reply text message designated corresponding to the key data, when a call, a message or an mail is received.

According to still another aspect of the present invention, there is provided a method for processing a reply in a mobile communication terminal, which comprises: displaying a reply menu to be selectable to an exterior key on an outer display or an inner display; and sending a corresponding reply text message stored in a memory according to selection of the displayed menu.

According to yet still another aspect of the present invention, there is provided a method for processing a reply in a mobile communication terminal, which comprises: receiving key data through a key operation, when a call, a message or an mail is received; and send a reply text message designated corresponding to the received key data.

### BRIEF DESCRIPTION OF THE DRAWINGS

The above aspects of the present invention will be more apparent by describing certain exemplary embodiments of the present invention with reference to the accompanying drawings, in which:

FIG. 1A to 1C show the configurations of a mobile communication terminal according to an exemplary embodiment of the present invention.

FIG. 2 is a block diagram illustrating a mobile communication terminal performing a reply processing method according to an exemplary embodiment of the present invention;

FIG. 3 is a block diagram explaining in detail a controller of FIG. 1;

FIG. 3 is a flow chart illustrating a method for processing the reply in the mobile communication terminal according to another exemplary embodiment of the present invention;

FIG. 5 is a diagram illustrating an example of a screen explaining the reply processing method when the mobile communication terminal receives a message, according to another exemplary embodiment of the present invention; and

FIG. 6 is a diagram illustrating an example of a screen explaining the reply processing method when the mobile communication terminal receives call, according to another exemplary embodiment of the present invention.

### DETAILED DESCRIPTION

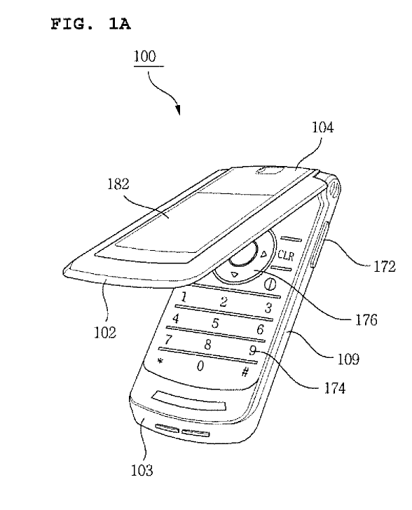

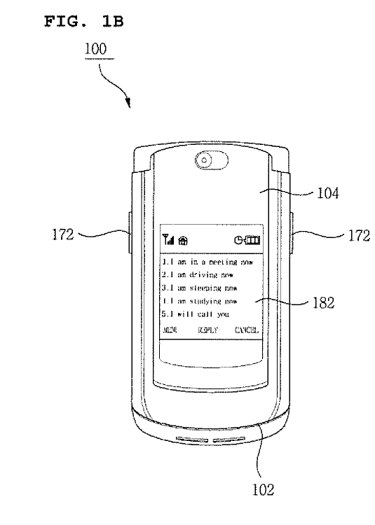

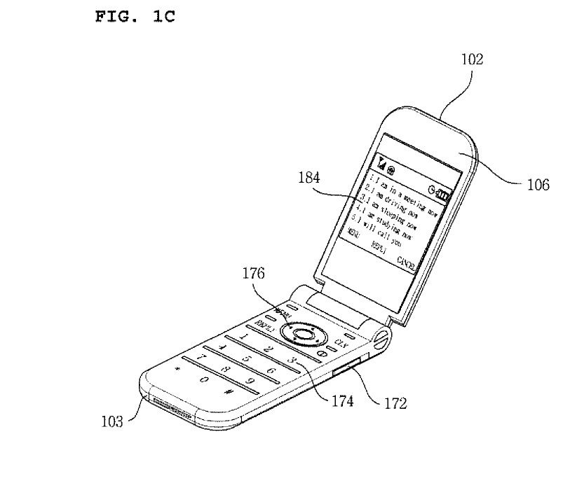

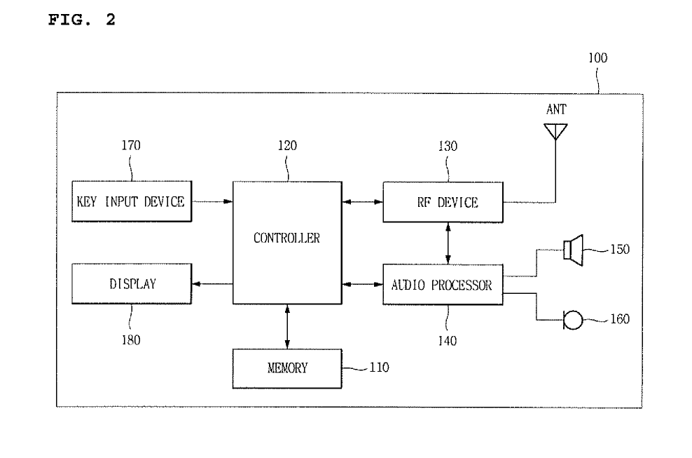

FIG. 1A to 1C show the configurations of a mobile communication terminal according to an exemplary embodiment of the present invention.

Referred to FIG. 1A to 1C, a mobile communication terminal 100 includes two bodies 102 and 104 which are connected by a hinge.

An outer display 182 is formed on an outer surface 104 of one body 102. An inner display 184 is formed on an inner surface 106 of the same body 102. The outer display 182 may display some states of the mobile communication terminal 100 as well as the specific information, for example, a reply menu and a previously text message in a closed state of two bodies 102 and 104 as explained below.

The plurality of a side key 172, numeral keys 174, navigation keys or function keys 176 are formed on the other body 104. The side key 172 is formed on circumference surface 109 of both sides of the other body 104. In a closed state of two bodies 102 and 104, if the side key 172 is selected, the outer display 182 may display some states of the mobile communication terminal 100 as well as the specific information, for example, a reply menu and a previously text message.

If one of the side key 172, the numeral keys 174, the navigation keys or function keys 176 is selected, the inner display 184 may display the same contents as the outer display 182 in an open state of two bodies 102 and 104.

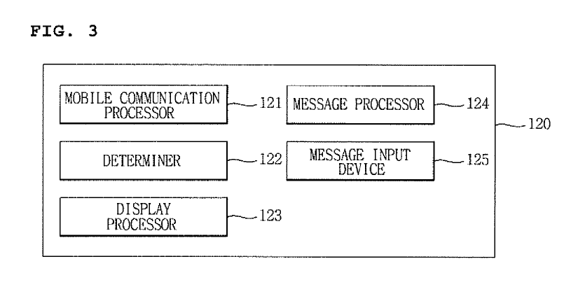

FIG. 2 is a block diagram illustrating a mobile communication terminal performing a reply processing method according to an exemplary embodiment of the present invention.

Referring to FIG. 2, the mobile communication terminal 100 includes a memory 110 storing a previously designated reply text message, a key input device 170 including an exterior key to select a reply menu, a controller 120 sending the corresponding reply text message stored in the memory 110 through an input operation of the exterior key when a call, a message or an mail is received, an RF device 130, an audio processor 140, a speaker 150, a microphone 160, and a display 180 including an inner display 184 and/or an outer display 812.

The memory 110 stores an operation program and a system program. The operation program and system program are generally stored in a ROM and can be erased, if necessary. The memory 110 also stores temporarily data generated during execution of various operation programs.

The memory 110 stores various information of the mobile communication terminal 100, a previously designed text message applied to the mobile communication terminal 100, a text message received by a user, a recorded moving image and a recorded audio. The text message is a reply message informing a caller of a reply disable situation of a receiver. The text message includes, for example, “I am in a meeting now”, “I am driving now”, “I am sleeping now” and “I will call you”.

In the embodiment, the text message includes the reply message informing the caller of a reply disable situation of the receiver, but not limited thereto. The reply text message can include all messages to be sent to the caller, for example, “thank you”, “have a nice day”, and the like.

The memory 110 stores reply procedures for processing the reply, when the reply is disabled. Accordingly, when the call, the message or the mail is received, the reply text message stored in the memory 110 can be simply sent to a mobile communication terminal 100 or an email address of the caller according to selection of an exterior key.

In the embodiment, when the call, the message or the mail is received, the reply text message is sent to the caller, but not limited thereto. For example, a moving image or an audio stored in the memory 110 may be sent to the caller.

The key input device 170 includes a plurality of the side key 172, the numeral keys 174, the navigation or function keys 176 that perform various functions, so as to output key data to the controller 120 through the key operation.

When the call, the message or the mail is received, if the exterior key or an optional key for reply is selected, the key input device 170 outputs the key data of the selected key to the controller 120.

The exterior key may include, for example, the side key 172 formed on a circumference surface 109 of the mobile communication terminal 100, but not limited thereto. The exterior key may be also implemented by any key protruded toward the outside. For example, if the key or push button is formed on the hinge toward the outside, it may function as the exterior key. For another example, when the outer display 182 is a touch input device such as a touch screen or a touch pad, the touch screen may function as the exterior key.

The optional key includes the side key 172, the numeral keys 174, the navigation or function keys 176, when other call or message is received while talking over the telephone or composing the message or mail. The optional key may include the key protruded toward the outside, a touch pad and a touch screen, each of which is provided with a key pad, when other call or message is received while talking over the telephone or composing the message or mail.

The display 180 includes the inner display 184 and the outer display 182. The display 180 includes all kind of display devices, for example, a Liquid Crystal Display (LCD), a Plasma Display Panel(PDP) or an Organic Light Emitting Diode (OLED).

The display 180 displays a state of the mobile communication terminal 100 or a progress situation of programs. In other words, the display 180 displays all states of the mobile communication terminal 100 and inputted user information.

In a closed state of two bodies 102 and 104, if the exterior key, for example, the side key 172 is selected, the outer display 182 may display some states of the mobile communication terminal 100 as well as the specific information, for example, a reply menu and a previously text message.

In an open state of two bodies 102 and 104, if one of the side key 172, the numeral keys 174, the navigation keys or function keys 176 is selected, the inner display 184 may display the same contents as the outer display 182

The controller 120 controls all operations of the mobile communication terminal 100 and simultaneously sends a corresponding reply text message stored in the memory 110 through the operation of the exterior key provided on the key input device 170, when the call, the message or the mail is received from a base station (not shown). Here, the reply text message includes all kind of messages, for example, a SMS message, an EMS message or a MMS message.

More particularly, when the call, the message or the mail is received in a state that previously designated reply text message are stored in the memory 110, the controller 120 displays a reply menu to be selectable to the exterior key on the outer display 182 or the inner display 184 and sends the reply text message stored in the memory 110 to the caller according to the selection of the displayed reply menu. The reply menu includes a text message list providing menu for sending the reply text message, where the receiver desires, to the caller and a reply menu for sending immediately the previously designated reply text message.

In the embodiment, the folder type mobile communication terminal 100 provided with the outer display 182 is mainly explained, but not limited thereto. The embodiment may be implemented by a bar type mobile communication terminal 100 and a slide type mobile communication terminal 100.

The RF device 130 converts a signal outputted from the controller 120 to a wireless signal under the control of the controller 120. In addition, the RF device 130 converts the wireless signal received through an antenna (ANT) to a desired signal to output the converted signal.

The audio processor 140 modulates an audio signal inputted from the microphone 160 and converts the modulated audio signal to audio data. Additionally, the audio processor 140 demodulates the audio data inputted from the RF device 130 and the audio data stored in the memory 110 to an audio signal so as to output an audio through the speaker 150.

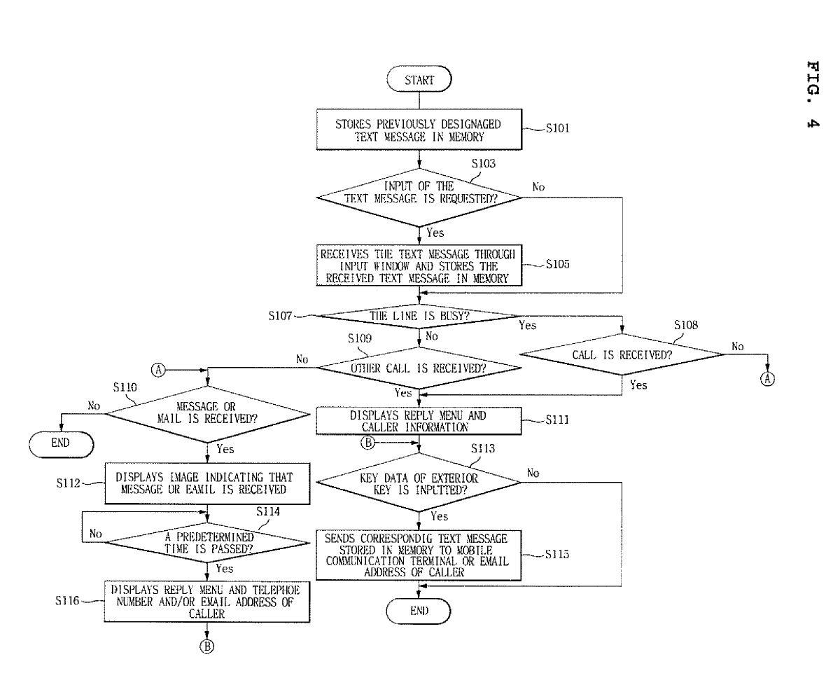

Referring to FIGS. 3, the controller 120 includes a mobile communication processor 121, a determiner 122, a display processor 123, a message processor 124 and a message input device 125, each of which performs a signal process for providing a mobile communication service.

The mobile communication processor 121 is a module providing the mobile communication service using a wireless resource in a mobile communication terminal 100. The detailed explanation will be omitted.

The determiner 122 determines whether the exterior key or optional key is inputted, when the call, the message or the mail is received.

In other words, the determiner 122 determines whether the exterior key provided on a circumference surface of the mobile communication terminal 100 is inputted, when the call, the message or the mail is received in a stat that a folder is closed.

The determiner 122 determines whether the optional key (for example, navigation key, OK key) provided in the mobile communication terminal 100 is inputted, when other call, message or mail is received while talking over the phone in the state that the folder is opened, and composing the message or mail.

The determiner 122 determines whether the input of the reply text message is requested.

The display processor 123 displays on the outer display 182 an image indicating on a screen that information, message or mail of the caller is received, and displays the image on the inner display 184 while talking over the phone and composing the message or mail.

Particularly, the display processor 123 displays the reply menu to be selectable according to the operation of the exterior key or optional key, when the exterior key or optional key is inputted. When the call is received, the display processor 123 displays information (e.g., name, mobile communication terminal, etc.) of the caller and the reply menu, and displays the mobile communication terminal 100 and email address of the caller, and the reply menu, when the message is received.

The message processor 124 inserts the reply text message stored in the memory 110 according to the menu selected from the reply menus displayed on the outer display 182 by the display processor 123 so as to send the inserted text message to the mobile communication terminal 100 of the caller.

More particularly, if the text message list providing menu among the reply menus is selected by the user, the message processor 124 provides a list of the reply text messages stored in the memory 110 to send the text message selected from the provided list to the mobile communication terminal of the caller. Accordingly, the receiver can promptly inform the caller of his/her present situation.

When other call, message or mail is received while talking over the phone, the message processor 124 sends the corresponding reply text message to the mobile communication terminal of the caller according to the menu selected from the reply menus displayed on the inner display 184.

The message input device 125 provides an input window that can input the reply text message in response to the input request of the reply text message from the receiver and receives the reply text message through the input window, so as to store the received text message in the memory 110. Accordingly, a reliable text message corresponding to the present situation of the receiver can be promptly sent to the caller.

As a result, even when the reply is disabled, the receiver can promptly and simply inform the caller of his/her present situation.

FIG. 4 is a flow chart illustrating a method for processing the reply in the mobile communication terminal according to another exemplary embodiment of the present invention.

Referring to FIG. 4, the controller 120 stores a previously designated text message in a memory 110 at S110.

Next, the determiner 122 of the controller 120 determines whether the input of the text message is requested at S103.

As a result of the step S103, if the input of the text message is not requested, the controller 120 progress to a step S107 that will be described below.

If the input of the text message is requested, the message input device 125 of the controller 120 provides an input window for inputting the reply text message, receives the text message through the provided input window, and stores the received text message in the memory 110. The received message includes a message that informs the caller of the reply disable state of the receiver, and a message that informs the caller of the present situation of the receiver.

Next, the determiner determines whether the mobile communication terminal is busy at S107.

If so, the determiner 122 determines whether other call is received at S108.

As a result of the step S108, if the other call is not received, it is determined whether the message or mail is received at S110. Like this, if the message or mail is received while talking over the phone, the reply menu and the telephone number and/or email address of the caller are displayed on the inner display 184.

As a result of the step S108, if the other call is received, the display processor 123 of the controller 120 displays the reply menu and caller information at the step S111. In this case, if the other call is received while talking over the phone, the reply menu and the caller information is displayed on the inner display 184.

As a result of the step S107, if the mobile communication terminal is not busy. The determiner 122 determines whether the call is received at S109.

As a result of the step S109, if the call is received, the display processor 123 of the controller 120 displays on the outer display 182 the reply menu and caller information to be selectable to the exterior key at S111 in a closed state of two bodies 102 and 104.

Next, the determiner 122 determines whether the key data of the exterior key is inputted at S133.

As the determination result of the step S113, if the key data of the exterior key is not inputted, the controller 120 completes the process after maintaining an idle state for a predetermined time.

As the determination result of the step S113, if the key data of the exterior key is inputted, the message processor 124 of the controller 120 detects the corresponding reply text message stored in the memory 110 and sends the detected reply text message to the mobile communication terminal of the caller in a closed state of two bodies 102 and 104 at S115.

As the determination result of the step S109, if the call is not received, the determiner 122 determines whether the message or mail is received at S110.

As the determination result of the step S110, if the message or mail is received, the display processor 123 displays on the outer display 182 an image indicating that the message or mail has been received at S112.

Next, the display processor 123 determines whether a predetermined time is passed after displaying the image on the outer display 182 at S114.

As the determination result of the step S114, after displaying the image, if the predetermined time is not passed, the controller 120 maintains the idle state.

As the determination result of the step S114, after displaying the image, if the predetermined time is passed, the display processor 123 displays on the outer display 182 the reply menu and the mobile communication terminal and/or email address of the caller at S116.

Next, in the step S113, the determiner determines whether the key data of the exterior key is inputted. If so, the message processor 124 sends the corresponding reply text message to the email address or the mobile communication terminal of the caller. In other words, the message processor 124 sends the corresponding reply text message to the email address of the caller, if the mail is received, and sends the corresponding reply text message to the mobile communication terminal of the caller, if the message is received.

As a result, the mobile communication terminal of the receiver immediately sends the reply text message that informs the caller of the reply disable state of the receiver or reply contents of the receiver, when the call, the message or the mail is received. Accordingly, the caller can recognize the present situation of the receiver.

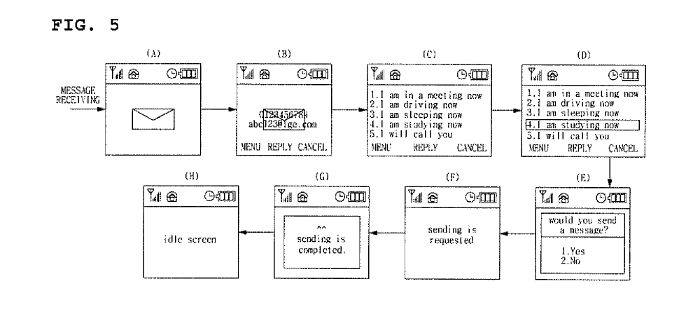

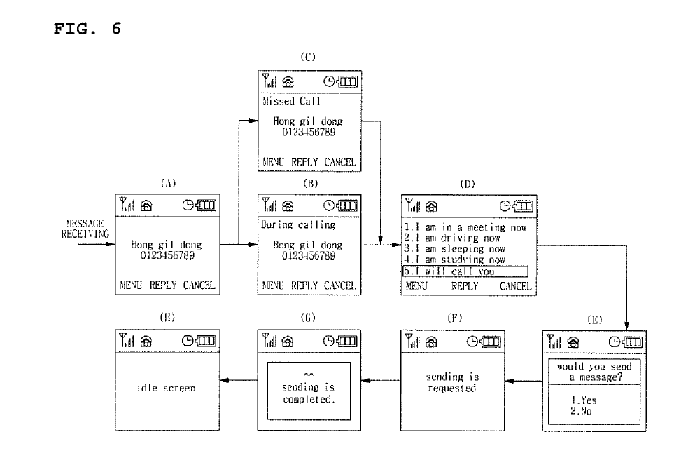

FIG. 5 is a diagram illustrating an example of a screen explaining the reply processing method when the mobile communication terminal receives a message, according to another exemplary embodiment of the present invention. FIG. 6 is a diagram illustrating an example of a screen explaining the reply processing method when the mobile communication terminal receives a call, according to another exemplary embodiment of the present invention.

The method for processing the reply in the mobile communication terminal will be explained with Reference to FIGS. 4 and 5.

First, referring to FIG. 5, if the message is received from the base station (not shown), the controller 120 displays on the outer display 182 an image indicating that the message has been received, as shown in FIG. 5(A), and displays the reply menu to be selectable to the exterior key and screen information including the telephone number and email address of the caller, as shown in FIG. 5 (B). In FIG. 5 (B), A “menu” is to select a text message list menu, a text message input menu, and the like, and a “reply” is to send the previously designated reply text message to the mobile communication terminal of the caller.

Next, the controller 120 provides the list of the reply text messages previously stored in the memory 110 as shown in FIG. 5(C), if the text message list menu is selected in FIG. 5(B).

In FIG. 5(B), if the reply menu is selected, the controller 120 detects the reply text message from the memory 110 and provides an OK window (refer to FIG. 5(E)) including a query message about whether to send the detected text message.

Next, the controller 120 selects the reply text message (e.g., 4. I am studying) to which the receiver desires, in the text message list shown in FIG. 5(D).

Next, as shown in FIG. 5(E), the controller 120 provides the OK window including the query message about whether to send the reply text message selected from FIG. 5(D) to the mobile communication terminal of the caller.

If the send of the message is requested in FIG. 5(E), the controller 120 displays a message indicating that the sending request for the corresponding reply text message is in progress, displays on the outer display 182 the message indicating that the sending of the corresponding reply text message has completed as shown in FIG. 5(G), and displays an idle screen of FIG. 5(H). Like this, the sent message is recorded to a send mail box.

In FIG. 5(B), even when the reply menu is selected, if the previously designated reply text message is not stored in the memory 110, an alarm message informing that the previously designated reply text message is not existed is displayed on the outer display 182 under the control of the controller 120.

Additionally, if the email address shown in FIG. 5(B) is not a reply email address, an alarm message informing that the email address had permanent fatal errors is displayed on the outer display 182 under the control of the controller 120.

Referring to FIG. 6, if the call is received from the base station (not shown), the caller information and reply menu are displayed on the outer display 182 under the control of the controller 120, as shown in FIG. 5(A).

Next, if the exterior key is selected while the call is received, an alarm message informing the caller of the present situation of the receiver, caller information and reply menu are displayed on the outer display 182 under the control of the controller 120, as shown in FIG. 6(B).

In this time, if the receiver can not answer the telephone, an alarm message informing the caller of a missed call, caller information and reply menu are displayed on the outer display 182 under the control of the controller 120 (refer to FIG. 6C).

If the text message list menu is selected through the operation of the exterior key in the state that the alarm message, caller information and reply menu are displayed on the outer display 182, the list of the previously designated text message is provided, as shown in FIG. 6(D).

As shown in FIG. 6(B) or 5(C), if the “reply menu” is selected, the controller 120 provides the OK window (refer to FIG. 6E) including a query message about whether to send the previously designated reply text message to the mobile communication terminal of the caller.

Next, the controller 120 provides the OK window including the query message about whether to send the reply text message of FIG. 6 to the mobile communication terminal of the caller, as shown in FIG. 6(E).

In the embodiment, the selected reply text message is immediately sent to the mobile communication terminal of the caller, but not limited thereto. For example, if the sending of the selected reply text message is requested after being displayed on the outer display 182, the selected reply text message may be sent to the caller.

Next, if the sending of the message is requested in FIG. 6(E), the message indicating that the sending request of the corresponding reply text message is in progress is displayed on the outer display 182 under to control of the controller 120, as shown in FIG. 6(F). If the sending is completed, the message indicating that the sending of the corresponding reply text message has completed is displayed on the outer display 182. Next, the idle screen of FIG. 6(H) is displayed.

Accordingly, the receiver simply can select the text message of the reply disable state and immediately send the selected text message to the mobile communication terminal of the caller.

In one embodiment, when the call, the message or the mail is received, the reply menu is displayed on the screen and the corresponding reply text message can be sent to the caller by selecting the menu using the exterior key. However, in other embodiment, when at least one of key data and at least one of the previously designated text message corresponding to each key data is stored in the memory without displaying the reply menu on the screen, if the call, the message or the mail is received from the base station, the key data may be received by the key operation and the reply text data stored in the memory corresponding to the received key data may be sent.

Although embodiment is described above, the present invention is not limited thereto.

According to the above-described embodiments, although the mobile communication terminal is a folder type terminal which connects two bodies by a hinge, the present invention is not limited thereto. The mobile communication terminal may be any kind of mobile communication terminals, for example, a slider type terminal or a swing type terminal.

According to the above-described embodiments, although the exterior key, for example, the side key is formed on the body with the keys, the present invention is not limited thereto. The exterior key may be formed on any one of two bodies.

According to the above-described embodiments, although the input device may be the key input device, the present invention is not limited thereto. The input device may include the touch input device, the voice input device as well as the key input device, which enable the mobile communication terminal to input any information or command in a closed or an open state of two bodies.

According to the above-described embodiments, although the outer and the inner displays are implemented on the same body, the present invention is not limited thereto. Both of them may be implemented on not only the same body but also other bodies. For example, the outer display is implemented on the outer surface of the cover body and the inner display is implemented on the inner surface of the main body.

According to the above-described embodiments, although the reply menu and the sender information are displayed on the outer display, and the selection of the reply menu is selected through the side key in the closed state of two bodies, the present invention is not limited thereto. The reply menu and the sender information may be displayed on the inner display, and the selection of the reply menu is selected through the numeral keys or the navigation or function keys in one of the closed of two bodies or the open state of two bodies.

The foregoing exemplary embodiments and aspects of the invention are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A mobile communication terminal comprising:
two bodies connected with each other;
a display device formed on an outer surface of one of the two bodies;
an input device enable to input any information or command in a close state of the two bodies;
a memory storing a previously designated text message; and
a controller displaying a reply menu on the display device and sending the previously designated text message stored in the memory according to selection of the menu through the input device, in the closed state of the two bodies.

2. The mobile communication terminal of claim 1, wherein the input device is a side key.

3. The mobile communication terminal of claim 1, wherein the two bodies are connected with each other by a hinge.

4. A mobile communication terminal comprising an inner display and an outer display, comprising:
a memory storing a previously designated text message; and
a controller displaying a reply menu to be selectable to an exterior key on the outer display or inner display and sending a corresponding text message stored in the memory according to selection of the menu, when a call, a message or an mail are received.

5. The mobile communication terminal of claim 4, wherein the text message informs a caller of a reply disable state.

6. The mobile communication terminal of claim 4, wherein the memory comprises a recorded moving image and a recorded audio, and the controller sends at least one of the recorded moving image and recorded audio.

7. The mobile communication terminal of claim 4, wherein the reply menu comprises a text message list providing menu and a reply menu.

8. The mobile communication terminal of claim 7, wherein the controller sends the previously designated text message in the memory to a caller.

9. The mobile communication terminal of claim 4, wherein the controller inserts a list of the text messages stored in the memory and sends the text message selected from the provided list to the caller.

10. The mobile communication terminal of claim 4, wherein the controller comprises:
a determiner determining whether an exterior key or an optional key is inputted, when the call, the message or the mail is received from the outside;
a display processor displaying a reply menu on the outer display, if the exterior key or optional key is inputted; and
a message processor inserts the text message stored in the memory to a menu selected from the displayed menus and sends the inserted text message to a mobile communication terminal of the caller.

11. The mobile communication terminal of claim 10, wherein the controller comprises a message input device that receives the text message by a user and stores the received text message in the memory.

12. The mobile communication terminal of claim 4, wherein the display processor displays the reply menu and the caller information, when the call is received.

13. The mobile communication terminal of claim 10, wherein the display processor displays the reply menu, an image showing the message or mail, a telephone number of the caller and/or an email address, when the message or mail is received.

14. The mobile communication terminal of claim 4, wherein the controller displays the reply menu on the inner display, when the message, mail or other call is received while talking over the phone and composing the message or mail.

15. A mobile communication terminal, comprising:
a memory storing at least one or more of previously designated key data and at least one of previously designated reply text messages corresponding to each key data; and
a controller receiving the key data through a key operation to send the reply text message designated by corresponding to the key data, when the call, message or mail is received.

16. The mobile communication terminal of claim 15, wherein the controller displays the reply menu to be selectable to the exterior key on a screen and sends a corresponding reply text message stored in the memory according to a menu selected by the key operation.

17. A method for processing a reply in a mobile communication terminal comprising an inner display, an outer display and a memory storing a previously designated text message, comprising:
(a) displaying a reply menu to be selectable to an exterior key on the outer display or the inner display, when a call or a message is received; and
(b) sending a corresponding reply text message stored in the memory according to selection of the displayed reply menu.

18. The method of claim 17, wherein the text message informs a caller of a reply disable state.

19. The method of claim 17, further comprising receiving the text message by a user and storing the received text message in the memory.

20. The method of claim 17, wherein the step (b) sends the previously designated text message in the memory to a caller.

21. The method of claim 17, wherein the step (b) provides a list of the text message stored in the memory and sends the text message selected from the inserted list to the caller.

22. The method of claim 17, wherein the step (a) comprises:
determining whether an exterior key or an optional key is inputted, when a call, a message or a mail is received from the outside; and
displaying a reply menu on the outer display, if the exterior key or optional key is inputted.

23. The method of claim 17, wherein the step (a) displays the reply menu on the inner display, when the message, mail or other call is received while talking over the phone and composing the message or mail.

24. A method for processing a reply in a mobile communication terminal comprising a memory storing at least one or more previously designated key data and at least one previously designated text message corresponding to each key data, comprising:
(a) receiving key data through a key operation, when a call, a message or a mail is received; and
(b) sending a reply text message designated by corresponding to the received key data.

25. The method of claim 24, wherein the step (b) displays a reply menu to be selectable to an exterior key on a screen and sends a corresponding text message stored in the memory according to a menu selected through the key operation.
